(19) United States
(12) Patent Application Publication
(10) Pub. No.: US 2026/0350827 A1
(43) Pub. Date: Nov. 5, 2026

(54) DEPTH SENSOR

(71) Applicant: SK hynix Inc., Icheon-si (KR)

(72) Inventors: Ji Hee HAN, Icheon-si (KR); Ju Hyun CHO, Icheon-si (KR)

(21) Appl. No.: 19/337,740

(22) Filed: Sep. 23, 2025

(30) Foreign Application Priority Data
Apr. 30, 2025 (KR) 10-2025-0057378

(51) Int. Cl. G06T 7/521; G01S 17/89; G06T 7/60; G06T 7/70

(52) U.S. Cl. CPC G06T 7/521; G01S 17/89; G06T 7/60; G06T 7/70; G06T 2207/10028

(57) ABSTRACT

Depth sensors are disclosed. In an embodiment, a depth sensor includes an identification processor configured to identify target areas corresponding to projected dots formed by reflected light from a target object and generate an identification image including the target areas, based on an input image having the projected dots, and an analysis processor configured to receive the identification image and analyze at least one distortion factor of the input image based on the identified target areas.

### CROSS-REFERENCE TO RELATED APPLICATION(S)

This patent document claims the priority and benefits of Korean Patent Application No. 10-2025-0057378, filed on Apr. 30, 2025, the disclosure of which is incorporated herein by reference in its entirety.

### TECHNICAL FIELD

The technology disclosed in this patent document generally relates to semiconductor design techniques, and more particularly, to depth sensors.

### BACKGROUND

LiDAR (light detection and ranging) is a type of depth sensor commonly used to measure the distance or depth to a target or object. It determines depth by analyzing the reflection of laser light that is directed to the target or object and the reflected laser light from the target or object.

The reflected laser light received by the LiDAR is projected in the form of dots through a sensor mounted on the LiDAR. These projected dots may be utilized to evaluate the performance of the LiDAR. Currently, evaluators or developers typically assess subjectively by visually inspecting the projected dots in a test environment.

### SUMMARY

Various embodiments of the disclosed technology provide a depth sensor designed to automatically perform self-performance evaluation.

In an embodiment of the disclosed technology, a depth sensor may include: an identification processor configured to identify target areas corresponding to projected dots formed by reflected light from a target object and generate an identification image including the target areas, based on an input image having the projected dots; and an analysis processor communicatively coupled to the identification processor and configured to receive the identification image and analyze at least one distortion factor of the input image based on the identified target areas.

In an embodiment of the disclosed technology, a depth sensor may include: an identification processor configured to identify target areas corresponding to projected dots formed by reflected light from a target object and generate an identification image including the target areas, based on an input image having the projected dots; and a first processor communicatively coupled to the identification processor and configured to analyze a first distortion factor related to focus by calculating a size of each of the target areas, based on the identification image.

The depth sensor may further include a second processor configured to analyze a second distortion factor related to an optical axis by calculating positions of some of the target areas, based on the identification image, and the second processor may be enabled or disabled depending on a first distortion factor analysis result.

In an embodiment of the disclosed technology, a depth sensor may include: a light emitter configured to emit light toward a target object; a light receiver configured to receive incident light reflected from the target object; an image sensor configured to detect projected dots formed by the incident light received through the light receiver and generate an input image including the projected dots; and an image processor communicatively coupled to the image sensor and configured to receive the input image and monitor characteristics of the light receiver by analyzing at least one distortion factor of the input image.

### BRIEF DESCRIPTION OF THE DRAWINGS

FIG. 1 is a block diagram illustrating a depth sensor based on an embodiment of the disclosed technology.

FIG. 2 is a block diagram illustrating an example of an image processor illustrated in FIG. 1.

FIG. 3 is a block diagram illustrating an identification processor illustrated in FIG. 2.

FIG. 4 is a block diagram illustrating a setting circuit illustrated in FIG. 3.

FIG. 5 is a block diagram illustrating a generation circuit illustrated in FIG. 3.

FIG. 6 is a block diagram illustrating a first processor illustrated in FIG. 2.

FIG. 7 is a block diagram illustrating a second processor illustrated in FIG. 2.

FIG. 8 is a block diagram illustrating another example of the image processor illustrated in FIG. 1.

FIGS. 9 to 11 are diagrams illustrating an operation of a depth sensor based on an embodiment of the disclosed technology.

### DETAILED DESCRIPTION

Various embodiments of the disclosed technology will now be described in detail with reference to the accompanying drawings.

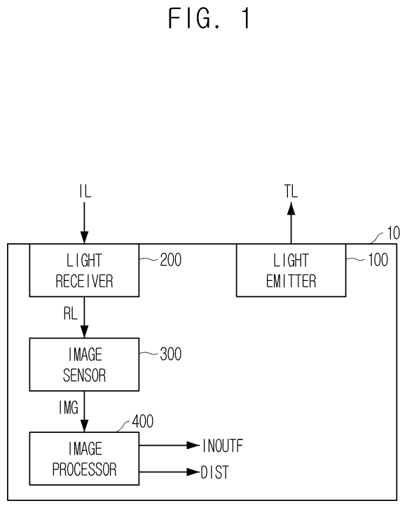

FIG. 1 is a block diagram illustrating a depth sensor 10 based on an embodiment of the disclosed technology.

Referring to FIG. 1, the depth sensor 10 may measure a distance, i.e., a depth, to at least one target or object (not illustrated) distributed within its field of view. For example, the depth sensor 10 may include LiDAR. The depth sensor 10 may include a light emitter 100, a light receiver 200, an image sensor 300, and an image processor 400.

The light emitter 100 may emit output light TL toward the field of view. For example, the light emitter 100 may include a laser such as a vertical cavity surface emitting laser (VCSEL) that produces laser light as the output light TL. When the output light TL reaches the target or object, it is reflected back from the target or object as incident light IL.

The light receiver 200 may capture the incident light IL that is reflected from the target or object. For example, the light receiver 200 may include a lens.

The image sensor 300 may detect an input light RL provided through the light receiver 200 and generate an input image IMG that includes projected dots. These projected dots may form a pattern (e.g., a grid or mesh) on the image sensor 300, and the image sensor 300 may generate the input image IMG including the projected dots.

The image processor 400 may receive the input image IMG and assess characteristics of the light receiver 200 by analyzing at least one distortion factor in the input image IMG. For example, the image processor 400 may analyze a first distortion factor related to focus by calculating the sizes of the projected dots, and may analyze a second distortion factor related to an optical axis by calculating positions of the projected dots. The image processor 400 may generate a first analysis result signal INOUTF indicating whether the focus is properly adjusted, based on a result of the first distortion factor analysis, and may generate a second analysis result signal DIST indicating whether the optical axis is properly aligned, based on a result of the second distortion factor analysis.

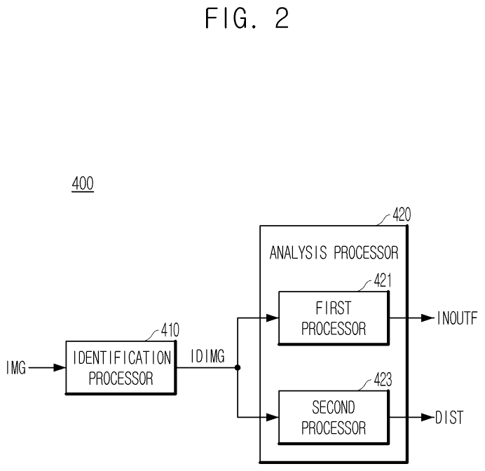

FIG. 2 is a block diagram illustrating an example of the image processor 400 illustrated in FIG. 1.

Referring to FIG. 2, the image processor 400 may include an identification processor 410 and an analysis processor 420.

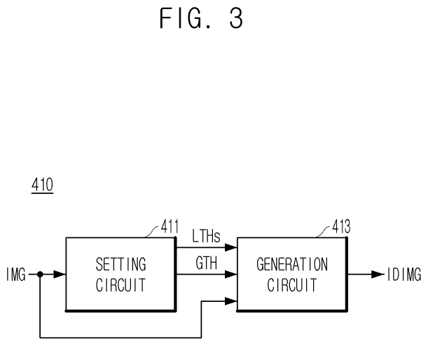

The identification processor 410 may identify target areas corresponding to the projected dots and generate an identification image IDIMG including the target areas, based on the input image IMG. Further details of the identification processor 410 are described with reference to FIGS. 3 to 5.

The analysis processor 420 may receive the identification image IDIMG and analyze the at least one distortion factor in the input image IMG based on the identified target areas. For example, the analysis processor 420 may include a first processor 421 and a second processor 423.

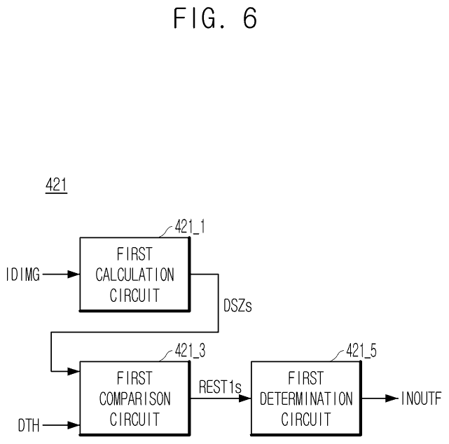

The first processor 421 may analyze the first distortion factor related to the focus by calculating the size of each of the target areas. Further details of the first processor 421 is described with reference to FIG. 6.

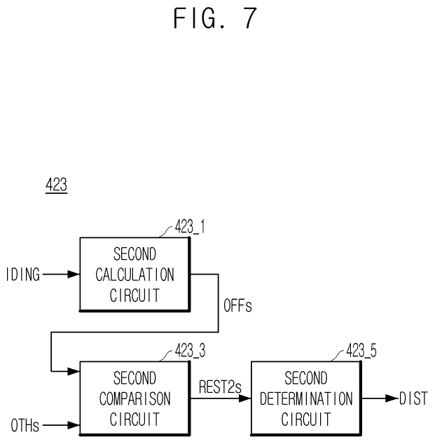

The second processor 423 may analyze the second distortion factor related to the optical axis by calculating the positions of selected target areas. The second processor 423 is described in more detail below with reference to FIG. 7.

Although an embodiment of the disclosed technology is described in which the analysis processor 420 includes the first processor 421 and the second processor 423, the disclosed technology is not limited thereto. In some embodiments, depending on design, either the first processor 421 or the second processor 423 may be included in the analysis processor 420.

FIG. 3 is a block diagram illustrating the identification processor 410 illustrated in FIG. 2.

Referring to FIG. 3, the identification processor 410 may include a setting circuit 411 and a generation circuit 413.

The setting circuit 411 may set a global threshold value GTH and local threshold values LTHs based on the input image IMG. For example, the global threshold value GTH may refer to a threshold value corresponding to the whole input image IMG, while the local threshold values LTHs may be threshold values corresponding to a portion (e.g., each kernel) of the input image IMG.

The generation circuit 413 may generate the identification image IDIMG including the target areas corresponding to the projected dots, based on the input image IMG, the global threshold value GTH and the local threshold values LTHs.

Although an embodiment of the disclosed technology is described in which the setting circuit 411 sets the global threshold value GTH and the local threshold values LTHs, the disclosed technology is not limited thereto. In some embodiments, only the global threshold value GTH or only the local threshold values LTHs may be generated. In such a case, the generation circuit 413 may generate the identification image IDIMG based only on the global threshold value GTH or only on the local threshold values LTHs.

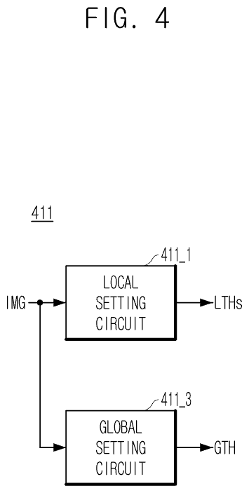

FIG. 4 is a block diagram illustrating the setting circuit 411 illustrated in FIG. 3.

Referring to FIG. 4, the setting circuit 411 may include a local setting circuit 411_1 or a global setting circuit 411_3, or may include both.

The local setting circuit 411_1 may generate the local threshold values LTHs based on the input image IMG. For example, the local setting circuit 411_1 may divide the input image IMG into a plurality of kernels and generate the local threshold values LTHs corresponding to the plurality of kernels. Each of the local threshold values LTHs may be generated based on Equation 1 below.

LTH#=α*LM# [Equation 1]

Here, “LTH#” may refer to one of the local threshold values LTHs, “α” may refer to a first weight for local, and “LM#” may refer to an average value of pixel values included in a certain kernel among the plurality of kernels.

The global setting circuit 411_3 may generate the global threshold value GTH based on the input image IMG. The global threshold value GTH may be generated based on Equation 2 below.

GTH=β*GM [Equation 2]

Here, “β” may refer to a second weight for global, and “GM” may refer to an average value of all pixel values included in the input image IMG.

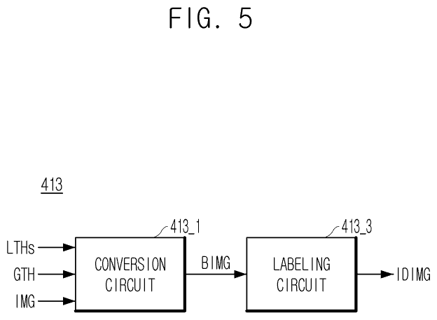

FIG. 5 is a block diagram illustrating the generation circuit 413 illustrated in FIG. 3.

Referring to FIG. 5, the generation circuit 413 may include a conversion circuit 413_1 and a labeling circuit 413_3.

The conversion circuit 413_1 may distinguish target areas from a background area in the input image IMG and generate a binary image BIMG that differentiates the target areas from the background area, based on the input image IMG, the global threshold value GTH and the local threshold values LTHs. For example, the binary image BIMG may be an image represented by binary image values, such as “0” and “1,” to respectively represent the background area and the target areas in the input image IMG. When a corresponding pixel value among the pixel values included in the input image IMG is greater than a corresponding local threshold value among the local threshold values LTHs and the global threshold value GTH, the corresponding pixel value may be converted into a binary image value, for example, “1,” corresponding to the target area. On the other hand, when a corresponding pixel value among the pixel values included in the input image IMG is less than a corresponding local threshold value among the local threshold values LTHs or the global threshold value GTH, the corresponding pixel value may be converted into a binary image value, for example, “0,” corresponding to the background area.

The labeling circuit 413_3 may generate the identification image IDIMG in which each target area is labeled based on the binary image BIMG. For example, the labeling circuit 413_3 may analyze the binary image BIMG for each kernel and generate the identification image IDIMG in which a label number is assigned to each of the projected dots, based on an analysis result. When the kernel corresponds to a pixel area including 3×3 pixels, the labeling circuit 413_3 may check the connectivity between a central pixel disposed at the center and each of peripheral pixels disposed on the periphery among the 3×3 pixels, and may assign the same label number when the analysis result indicates that two pixels are connected to each other. In other words, the labeling circuit 413_3 may assign the same label number to at least one pixel included in (or corresponding to) the same target area (e.g., one of the projected dots) as the analysis result. Conversely, the labeling circuit 413_3 may assign different label numbers when the analysis result indicates that the two pixels are not connected to each other. In other words, the labeling circuit 413_3 may assign different label numbers to pixels included in (or corresponding to) different target areas (e.g., each of the projected dots) as the analysis result. The labeling circuit 413_3 may perform an analysis operation when the central pixel has the binary image value, for example, “1,” corresponding to the target area, and may omit the analysis operation when the central pixel has the binary image value, for example, “0,” corresponding to the background area.

FIG. 6 is a block diagram illustrating the first processor 421 illustrated in FIG. 2.

Referring to FIG. 6, the first processor 421 may include a first calculation circuit 421_1, a first comparison circuit 421_3, and a first determination circuit 421_5.

The first calculation circuit 421_1 may calculate the size of each of the target areas. For example, the first calculation circuit 421_1 may determine the size of each of the target areas by calculating the number of binary image values, for example, the number of the value “1,” representing each of the target areas. The first calculation circuit 421_1 may generate a first information signal DSZS corresponding to the size of each of the target areas.

The first comparison circuit 421_3 may compare the size of each of the target areas with a predetermined threshold size based on the first information signal DSZS and a first threshold information signal DTH. For example, the first comparison circuit 421_3 may compare the number of binary image values, for example, the number of value “1,” representing each of the target areas with a threshold count corresponding to the predetermined threshold size. The first comparison circuit 421_3 may generate a first comparison result signal REST1S corresponding to a comparison result of comparing the size of each of the target areas with the predetermined threshold size.

The first determination circuit 421_5 may determine whether focus of the projected dots is properly adjusted, based on the first comparison result signal REST1S corresponding to the comparison result from the first comparison circuit 421_3. For example, the first determination circuit 421_5 may generate the first analysis result signal INOUTF indicating an in-focus state when the size of target areas that are greater than the predetermined threshold size among the target areas is relatively small. On the other hand, the first determination circuit 421_5 may generate the first analysis result signal INOUTF indicating an out-of-focus state when the size of target areas that are greater than the predetermined threshold size among the target areas is relatively large.

FIG. 7 is a block diagram illustrating the second processor 423 illustrated in FIG. 2.

Referring to FIG. 7, the second processor 423 may include a second calculation circuit 423_1, a second comparison circuit 423_3, and a second determination circuit 423_5.

The second calculation circuit 423_1 may calculate offset values OFFs corresponding to the positions of target areas that are closest to the corners of the identification image IDIMG among the target areas. For example, the second calculation circuit 423_1 may calculate first offset values of a target area disposed at the upper-leftmost position among the target areas, second offset values of a target area disposed at the upper-rightmost position among the target areas, third offset values of a target area disposed at the lower-leftmost position among the target areas, and fourth offset values of a target area disposed at the lower-rightmost position among the target areas. The offset values OFFs may include horizontal and vertical coordinate values of a central pixel included in a corresponding target area.

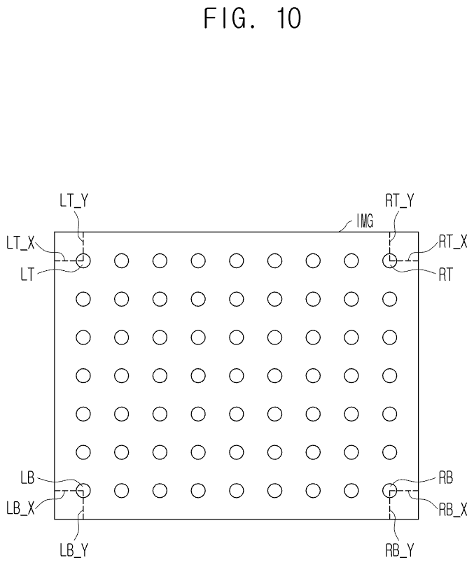

The second comparison circuit 423_3 may compare the offset values OFFs with predetermined reference offset values OTHs and generate a second comparison result signal REST2S corresponding to the comparison results. For example, the second comparison circuit 423_3 may check whether each of the offset values OFFs falls within an allowable error range based on each of the reference offset values OTHs and generate the second comparison result signal REST2S corresponding to the check result. In some implementations, the allowable error range may refer to an acceptable range for the absolute difference between a given offset value and its corresponding reference offset value. The reference offset values OTHs may be extracted from an image in which the optical axis is well aligned (refer to FIG. 10).

The second determination circuit 423_5 may determine whether the optical axis is properly aligned, based on the second comparison result signal REST2S corresponding to the comparison results from the second comparison circuit 423_3. For example, the second determination circuit 423_5 may generate the second analysis result signal DIST indicating that the optical axis is well-aligned when each of the offset values OFFs falls within the allowable error range with respect to each of the reference offset values OTHs. On the other hand, the second determination circuit 423_5 may generate the second analysis result signal DIST indicating that the optical axis is not properly aligned when at least one of the offset values OFFs falls outside the allowable error range with respect to each of the reference offset values OTHs.

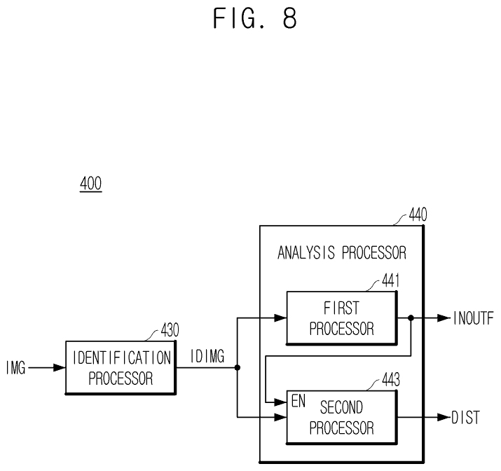

FIG. 8 is a block diagram illustrating another example of the image processor 400 illustrated in FIG. 1.

Referring to FIG. 8, the image processor 400 may include an identification processor 430 and an analysis processor 440. In some embodiments, the identification processor 430 is identical to the identification processor 410 illustrated in FIG. 2. Therefore, a detailed description thereof will be omitted. In some embodiments, the analysis processor 440 is similar to the analysis processor 420 illustrated in FIG. 2, and therefore, only the features different from the analysis processor 420 will be described below.

The analysis processor 440 may include a first processor 441 or a second processor 443, or may include both of the first and second processors.

The second processor 443 may be enabled or disabled based on the first analysis result signal INOUTF. For example, the second processor 443 may be enabled when an analysis result of the first processor 441 indicates that the projected dots are in an in-focus state, and may be disabled when the analysis result of the first processor 441 indicates that the projected dots are in an out-of-focus state. When the second processor 443 is enabled, it may be determined whether the optical axis is properly aligned, and when the second processor 443 is disabled, it may not perform the determination of the optical axis alignment. The accuracy of determining whether the optical axis is aligned may be significantly reduced when the second processor 443 determines whether the optical axis is aligned while the projected dots are out of focus. Accordingly, the second processor 443 may be disabled according to the first analysis result signal INOUTF when the projected dots are out of focus.

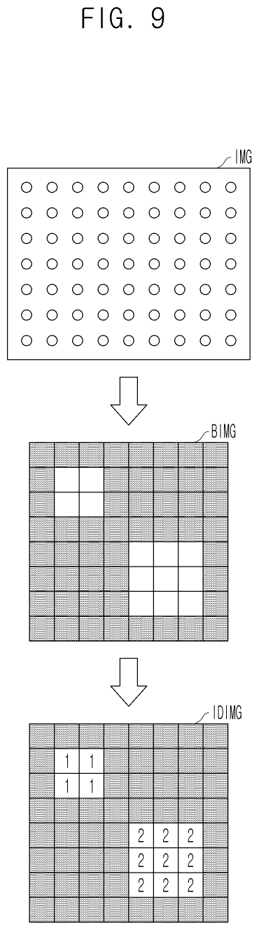

Hereinafter, an operation of the depth sensor 10 based on an embodiment of the disclosed technology, which has the above-described configuration, will be described with reference to FIGS. 9 to 11.

When the light emitter 100 emits the output light TL toward the field of view, the incident light IL, which is the output light TL reflected from the target or object, may be projected in the form of dots onto the image sensor 300 through the light receiver 200. The image sensor 300 may generate the input image IMG including the projected dots based on the input light RL.

The image processor 400 may monitor the characteristics of the light receiver 200 by analyzing at least one distortion factor of the input image IMG based on the input image IMG. For example, the image processor 400 may analyze the first distortion factor related to focus by calculating the sizes of the projected dots, and may analyze the second distortion factor related to the optical axis by calculating the positions of the projected dots. The image processor 400 may generate the first analysis result signal INOUTF indicating whether the focus is properly aligned based on the analysis result of the first distortion factor, and may generate the second analysis result signal DIST indicating whether the optical axis is properly aligned based on the analysis result of the second distortion factor.

FIG. 9 illustrates an example operation of the identification processor 411.

Referring to FIG. 9, the conversion circuit 413_1 may distinguish between the target areas and background area included in the input image IMG and generate the binary image BIMG in which the target areas and the background area are separated, based on the input image IMG, the global threshold value GTH and the local threshold values LTHs. For example, the binary image BIMG may be an image expressed using two binary image values, for example, “0” and “1,” to distinguish the target areas from the background area in the input image IMG. When a pixel value among the pixel values included in the input image IMG is greater than the corresponding local threshold value among the local threshold values LTHs and the global threshold value GTH, the pixel value may be converted into the binary image value, for example, the value “1,” corresponding to the target area. On the other hand, when a pixel value among the pixel values included in the input image IMG is less than the corresponding local threshold value among the local threshold values LTHs or the global threshold value GTH, the pixel value may be converted into the binary image value, for example, the value “0,” corresponding to the background area.

The labeling circuit 413_3 may generate the identification image IDIMG in which each target area is labeled, based on the binary image BIMG. For example, the labeling circuit 413_3 may analyze the binary image BIMG for each kernel and generate the identification image IDIMG in which a label number is assigned to each of the projected dots, based on an analysis result. When the kernel corresponds to a pixel area including 3×3 pixels, the labeling circuit 413_3 may analyze the connectivity between a central pixel disposed at the center and each of peripheral pixels disposed on the periphery among the 3×3 pixels, and may assign the same label number when the analysis result indicates that two pixels are connected to each other. In other words, the labeling circuit 413_3 may assign the same label number to at least one pixel included in (or corresponding to) the same target area (e.g., one of the projected dots) as the analysis result. Conversely, the labeling circuit 413_3 may assign different label numbers when the analysis result indicates that the two pixels are not connected to each other. In other words, the labeling circuit 413_3 may assign different label numbers to pixels included in (or corresponding to) different target areas (e.g., each of the projected dots) as the analysis result. The labeling circuit 413_3 may perform the analysis operation when the central pixel has the binary image value, for example, “1,” corresponding to the target area, and may omit the analysis operation when the central pixel has the binary image value, for example, “0,” corresponding to the background area.

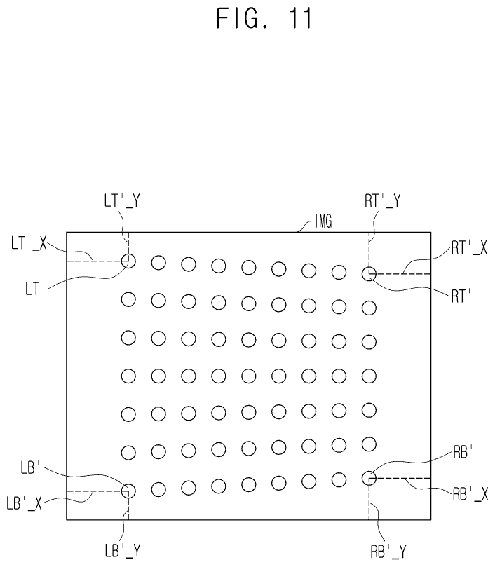

FIGS. 10 and 11 illustrate an example of the operation of the second processor 423.

FIG. 10 illustrates a reference image IMG of which optical axis is well aligned.

Referring to FIG. 10, the second processor 423 may directly extract the reference offset values OTHs or receive the reference offset values OTHs from an external device.

According to an example, the second calculation circuit 423_1 may calculate the reference offset values OTHs corresponding to the positions of target areas that are closest to the corners of the identification image IDIMG among the target areas. For example, the second calculation circuit 423_1 may calculate first and second reference offset values LT_X and LT_Y of a target area LT disposed at the upper-leftmost among the target areas, third and fourth reference offset values RT_X and RT_Y of a target area RT disposed at the upper-rightmost among the target areas, fifth and sixth reference offset values LB_X and LB_Y of a target area LB disposed at the lower-leftmost among the target areas, and seventh and eighth reference offset values RB_X and RB_Y of a target area RB disposed at the lower-rightmost among the target areas. The first to eighth reference offset values LT_X, LT_Y, RT_X, RT_Y, LB_X, LB_Y, RB_X and RB_Y may represent the distances from central pixels of the respective target areas to the nearest horizontal or vertical edges of the reference image IMG.

In another example, the reference offset values OTHs including the first to eighth reference offset values LT_X, LT_Y, RT_X, RT_Y, LB_X, LB_Y, RB_X and RB_Y may be provided from the external device.

FIG. 11 illustrates a target image IMG of which optical axis is not well aligned.

Referring to FIG. 11, the second calculation circuit 423_1 may calculate the offset values OFFs corresponding to the positions of target areas that are closest to the corners of the identification image IDIMG among the target areas. For example, the second calculation circuit 423_1 may calculate first and second offset values LT′_X and LT′_Y of a target area LT′ disposed at the upper-leftmost among the target areas, third and fourth offset values RT′_X and RT′_Y of a target area RT′ disposed at the upper-rightmost among the target areas, fifth and sixth offset values LB′_X and LB′_Y of a target area LB′ disposed at the lower-leftmost among the target areas, and seventh and eighth offset values RB′_X and RB′_Y of a target area RB′ disposed at the lower-rightmost among the target areas. The first to eighth offset values LT′_X, LT'_Y, RT′_X, RT′_Y, LB′_X, LB′_Y, RB′_X and RB′_Y may be distances from central pixels of the respective target areas to the nearest horizontal or vertical edges of the target image IMG.

The second comparison circuit 423_3 may compare the offset values OFFs with the reference offset values OTHs and generate the second comparison result signal REST2S corresponding to the comparison result.

For example, the second comparison circuit 423_3 may check whether each of the offset values OFFs falls within an allowable error range based on each of the reference offset values OTHs and generate the second comparison result signal REST2S corresponding to the check result. In some implementations, the allowable error range may refer to an acceptable range, e.g., the absolute difference between a given offset value and its corresponding reference offset value.

The second determination circuit 423_5 may determine whether the optical axis is properly aligned, based on the second comparison result signal REST2S corresponding to the comparison result from the second comparison circuit 423_3. For example, the second determination circuit 423_5 may generate the second analysis result signal DIST indicating that the optical axis is well-aligned when each of the offset values OFFs falls within the allowable error range based on the reference offset values OTHs. On the other hand, the second determination circuit 423_5 may generate the second analysis result signal DIST indicating that the optical axis is not properly aligned when at least one of the offset values OFFs falls outside the allowable error range based on each of the reference offset values OTHs.

Some embodiments of the disclosed technology provide techniques that combine auto-focusing and auto-alignment algorithms. In some embodiments, the auto-focusing algorithm operates as follows. When a light ray such as a VCSEL-emitted laser ray is accurately focused onto the image plane of an image sensor such as the LiDAR sensor, the projected dot appears as a single sharp dot. In contrast, in an out-of-focus state, the projected dot appears as a larger circle. In some embodiments, the algorithm processes the laser projection image as input, applies both local and global thresholds to generate a binary image, and uses labeling to isolate individual dot regions. The size of each labeled dot region is then measured. If the size falls below a predefined threshold, the dot is considered in-focus, and otherwise, it is classified as out-of-focus. In some embodiments, the auto-alignment algorithm determines whether the optical axes of the LiDAR sensor and the VCSEL are properly aligned. When the optical axes are misaligned, various types of distortion may appear in the laser projection image. To assess alignment, the auto-alignment algorithm first identifies dot regions located near each of the four corners of the identification image. For each of these dot regions, the algorithm extracts the coordinates of its center pixel, which serves as a representative position for that region. Next, it calculates offset values by measuring distances between the center pixels of the corner dot regions and the corresponding image corners. These offsets represent relative spacing between the center pixels of the corner dot regions and the corresponding image corners. If the differences among these offset values fall within a predefined threshold, the optical axis is determined to be well-aligned. Otherwise, it is determined that there is misalignment. This automated approach enables accurate and consistent alignment verification.

In an embodiment of the disclosed technology, self-performance evaluation may be automatically performed.

In an embodiment of the disclosed technology, self-performance evaluation may be automatically performed, thereby reducing human error and improve the accuracy and efficiency of the evaluation.

The embodiments and implementations disclosed above are examples only, and thus various enhancements and variations to the disclosed embodiments and implementations and other embodiments and implementations can be made based on what is described and illustrated in this patent document.

What is claimed is:

1. A depth sensor comprising:
an identification processor configured to identify target areas corresponding to projected dots formed by reflected light from a target object and generate an identification image including the target areas, based on an input image including the projected dots; and
an analysis processor communicatively coupled to the identification processor and configured to receive the identification image and analyze at least one distortion factor of the input image based on the identified target areas.

2. The depth sensor of claim 1, wherein the identification processor includes:
a setting circuit configured to set at least one threshold value based on the input image; and
a generation circuit configured to generate the identification image based on the input image and the at least one threshold value.

3. The depth sensor of claim 2, wherein the setting circuit includes at least one of a global setting circuit or a local setting circuit,
wherein the global setting circuit sets a global threshold value based on the input image, and the local setting circuit sets local threshold values based on the input image, and
wherein the at least one threshold value includes the global threshold value, the local threshold values, or both the global threshold value and the local threshold values.

4. The depth sensor of claim 2, wherein the generation circuit includes:
a conversion circuit configured to distinguish the target areas from a background area in the input image and generate a binary image that differentiates the target areas from the background area, based on pixel values included in the input image and the at least one threshold value; and
a labeling circuit configured to generate the identification image by labeling each target area, based on the binary image.

5. The depth sensor of claim 1, wherein the analysis processor includes at least one of a first processor or a second processor, and
wherein the first processor analyzes a first distortion factor related to focus by calculating a size of each of the target areas, and
the second processor analyzes a second distortion factor related to an optical axis by calculating positions of one or more selected target areas of the target areas.

6. The depth sensor of claim 5, wherein the second processor is enabled or disabled depending on a first distortion factor analysis result.

7. The depth sensor of claim 5, wherein the first processor includes:
a first calculation circuit configured to calculate the size of each of the target areas;
a first comparison circuit configured to compare the size of each of the target areas with a predetermined threshold size; and
a first determination circuit configured to determine whether the projected dots corresponding to the target areas are in focus, based on a comparison result of the first comparison circuit.

8. The depth sensor of claim 5, wherein the second processor includes:
a second calculation circuit configured to calculate offset values corresponding to positions of target areas that are closest to respective corners of the identification image among the target areas;
a second comparison circuit configured to compare the offset values with predetermined reference offset values; and
a second determination circuit configured to determine whether the optical axis is aligned, based on a comparison result of the second comparison circuit.

9. A depth sensor comprising:
an identification processor configured to identify target areas corresponding to projected dots formed by reflected light from a target object and generate an identification image including the target areas, based on an input image having the projected dots; and
a first processor communicatively coupled to the identification processor and configured to analyze a first distortion factor related to focus by calculating a size of each of the target areas, based on the identification image.

10. The depth sensor of claim 9, further comprising a second processor configured to analyze a second distortion factor related to an optical axis by calculating positions of some of the target areas, based on the identification image,
wherein the second processor is enabled or disabled depending on a first distortion factor analysis result.

11. A depth sensor comprising:
a light emitter configured to emit light toward a target object;
a light receiver configured to receive incident light reflected from the target object;
an image sensor configured to detect projected dots formed by the incident light received through the light receiver and generate an input image including the projected dots; and
an image processor communicatively coupled to the image sensor and configured to receive the input image and monitor characteristics of the light receiver by analyzing at least one distortion factor of the input image.

12. The depth sensor of claim 11, wherein the image processor analyzes the distortion factor of the input image by calculating sizes the projected dots, or positions of the projected dots, or sizes and positions of the projected dots.

13. The depth sensor of claim 11, wherein the image processor includes:
an identification processor configured to identify target areas corresponding to the projected dots and generate an identification image including the target areas, based on the input image; and
an analysis processor configured to receive the identification image and analyze the at least one distortion factor of the input image based on the target areas.

14. The depth sensor of claim 13, wherein the identification processor includes:
a setting circuit configured to set at least one threshold value based on the input image; and
a generation circuit configured to generate the identification image based on the input image and the at least one threshold value.

15. The depth sensor of claim 14, wherein the setting circuit includes at least one of a global setting circuit or a local setting circuit,
wherein the global setting circuit sets a global threshold value based on the input image, and the local setting circuit sets local threshold values based on the input image, and
wherein the at least one threshold value includes the global threshold value, the local threshold values, or both the global threshold value and the local threshold values.

16. The depth sensor of claim 14, wherein the generation circuit includes:
a conversion circuit configured to distinguish the target areas from a background area in the input image and generate a binary image that differentiates the target areas from the background area, based on pixel values included in the input image and the at least one threshold value; and
a labeling circuit configured to generate the identification image by labeling each target area, based on the binary image.

17. The depth sensor of claim 13, wherein the analysis processor includes at least one of a first processor or a second processors, and
wherein the first processor analyzes a first distortion factor related to focus by calculating a size of each of the target areas, and
the second processor analyzes a second distortion factor related to an optical axis by calculating positions of one or more selected target areas of the target areas.

18. The depth sensor of claim 17, wherein the second processor is enabled or disabled depending on a first distortion factor analysis result.

19. The depth sensor of claim 17, wherein the first processor includes:
a first calculation circuit configured to calculate the size of each of the target areas;
a first comparison circuit configured to compare the size of each of the target areas with a predetermined threshold size; and
a first determination circuit configured to determine whether the projected dots corresponding to the target areas are in focus, based on a comparison result of the first comparison circuit.

20. The depth sensor of claim 17, wherein the second processor includes:
a second calculation circuit configured to calculate offset values corresponding to positions of target areas that are closest to respective corners of the identification image among the target areas;
a second comparison circuit configured to compare the offset values with predetermined reference offset values; and
a second determination circuit configured to determine whether the optical axis is aligned, based on a comparison result of the second comparison circuit.
